(19) United States
(12) Patent Application Publication
(10) Pub. No.: US 2021/0053674 A1
(43) Pub. Date: Feb. 25, 2021

(54) COMPOSITE SKID MEMBERS

(71) Applicant: Bell Textron Inc, Fort Worth, TX (US)

(72) Inventors: Timothy Brian Carr, Fort Worth, TX (US); William Anthony Amante, Grapevine, TX (US); Brian John Cox, Keller, TX (US)

(21) Appl. No.: 16/545,422

(22) Filed: Aug. 20, 2019

(51) Int. Cl. B64C 25/52; B64C 27/04; B29C 70/52; B29C 70/54

(52) U.S. Cl. CPC B64C 25/52; B64C 27/04; B29L 2031/3082; B29C 70/545; B29C 70/52

(57) ABSTRACT

Various implementations directed to composite skid members are provided. In one implementation, an aircraft landing gear assembly may include two skid members configured to contact the ground, where each skid member includes composite material manufactured using a pultrusion process. The aircraft landing gear assembly may also include a plurality of cross members configured to couple to a fuselage of an aircraft and configured to interconnect the two skid members.

STATEMENT REGARDING FEDERALLY SPONSORED RESEARCH OR DEVELOPMENT

Not applicable.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

The landing gear used by aircraft may be configured to support the aircraft on the ground and allow the aircraft to taxi, takeoff, and/or land. For some aircraft, such as helicopters or other rotorcraft, the landing gear may be a skid landing gear. The skid landing gear may provide energy attenuation in various types of landings, including normal landings, hard landings, auto-rotations, and crash landings. In addition, the skid landing gear may be dynamically tuned to avoid ground resonance, such as in roll and shuffle modes.

Conventional skid landing gear may include a pair of cross members attached to a pair of skid members. Some skid members may be made from aluminum extrusions or seamless drawn aluminum tubes, where the skid members may also be chemically milled in order to reduce weight where possible. However, chemical milling may present environmental complications and may require a relatively long lead time for manufacturing. Thus, the design of a cost-effective, environmentally sensitive, and relatively lightweight landing gear that requires less manufacturing time has presented challenges to engineers and manufacturers.

### SUMMARY

Described herein are implementations of various technologies relating to composite skid members. In one implementation, an aircraft landing gear assembly may include two skid members configured to contact the ground, where each skid member includes composite material manufactured using a pultrusion process. The aircraft landing gear assembly may also include a plurality of cross members configured to couple to a fuselage of an aircraft and configured to interconnect the two skid members.

In another implementation, an aircraft may include a fuselage and an aircraft landing gear assembly. The aircraft landing gear assembly may include two skid members configured to contact the ground, where each skid member includes composite material. The aircraft landing gear assembly may also include a plurality of cross members configured to couple to the fuselage and configured to interconnect the two skid members.

In yet another implementation, a method may include pulling continuous reinforcement material through an impregnation mechanism to impregnate the continuous reinforcement material with resin. The method may also include pulling the impregnated continuous reinforcement material through a curing die to form a cured product. The method may further include cutting the cured product into predetermined lengths to form one or more pultruded composite skid members for use with an aircraft landing gear assembly.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of an aircraft in accordance with implementations of various techniques described herein.

FIG. 2 illustrates a partial schematic diagram of a landing gear assembly in accordance with implementations of various techniques described herein.

FIG. 3 illustrates a schematic diagram of a system for producing a composite skid member using a pultrusion process in accordance with implementations of various techniques described herein.

FIG. 4 illustrates a flow diagram of a method 400 for producing a composite skid member using a pultrusion process in accordance with implementations of various techniques described herein.

### DETAILED DESCRIPTION

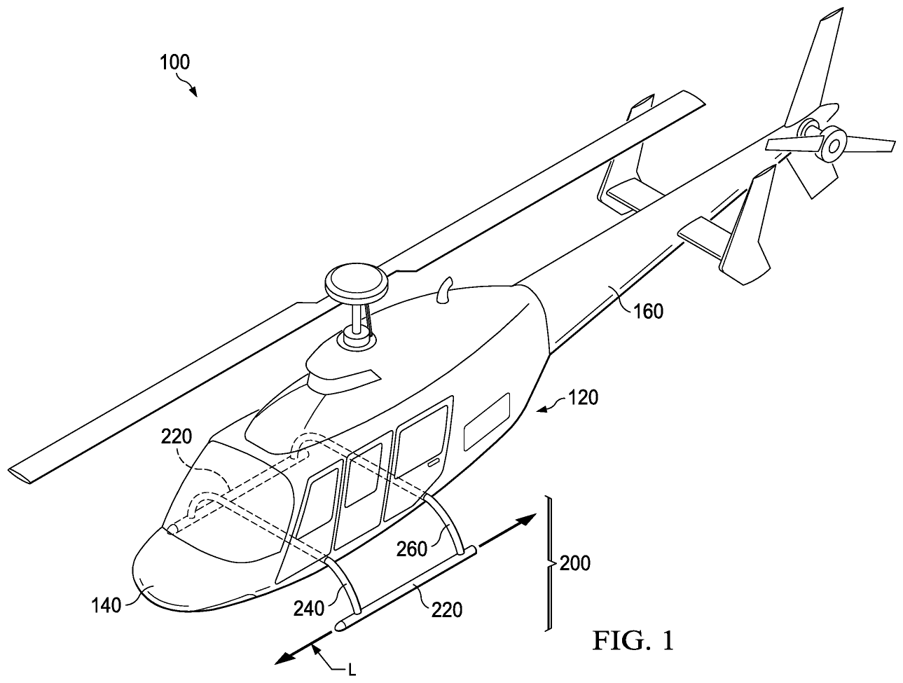

Various implementations directed to composite skid members will now be described in the following paragraphs with reference to FIGS. 1-4.

As noted above, aircraft may use skid landing gear, where the skid landing gear may be configured to support the aircraft on the ground, allow the aircraft to taxi, takeoff, and/or land, provide energy attenuation in various types of landings, and may be dynamically tuned to avoid critical ground resonance modes.

For example, FIG. 1 illustrates a schematic diagram of an aircraft 100 in accordance with implementations of various techniques described herein. As shown, the aircraft 100 may include a fuselage 120 having a cabin portion 140 and a tail boom 160. The aircraft 100 as depicted in FIG. 1 is a helicopter, though those skilled in the art will understand that the implementations described herein may be applied to any type of aircraft, including, but not limited to, other types of rotorcraft (e.g., gyrocopters), ultralight aircraft, vertical take-off and landing (VTOL) aircraft, sport aviation aircraft, military aircraft, general aviation aircraft, or commercial passenger aircraft. Further, the aircraft 100 may be powered by one or more engines, a propulsion system such as a rotor system, and a flight control system.

In addition, a landing gear assembly 200 may be coupled to a bottom portion of the fuselage 120. The landing gear assembly 200 may be composed of structural members, such as two longitudinal skid members 220, a front cross member 240, and a rear cross member 260.

The longitudinal skid members 220 may be configured to contact the ground. The longitudinal direction of the skid members 220 is indicated by the longitudinal axis L shown in FIG. 1, where the axis L is horizontal and parallel to a horizontal ground surface when the aircraft 100 rests on the ground surface. The front and rear cross members 240, 260 may be coupled to the fuselage 120 using any fittings (not shown) known to those skilled in the art, where the fittings may be external or internal to the fuselage 120. The cross members 240, 260 may be used to interconnect the two skid members 220. In particular, the longitudinal skid members 220 and the cross members 240, 260 may together be configured to provide energy attenuation for various landings of the aircraft 100, such as through elastic and plastic deformation of the cross members 240, 260.

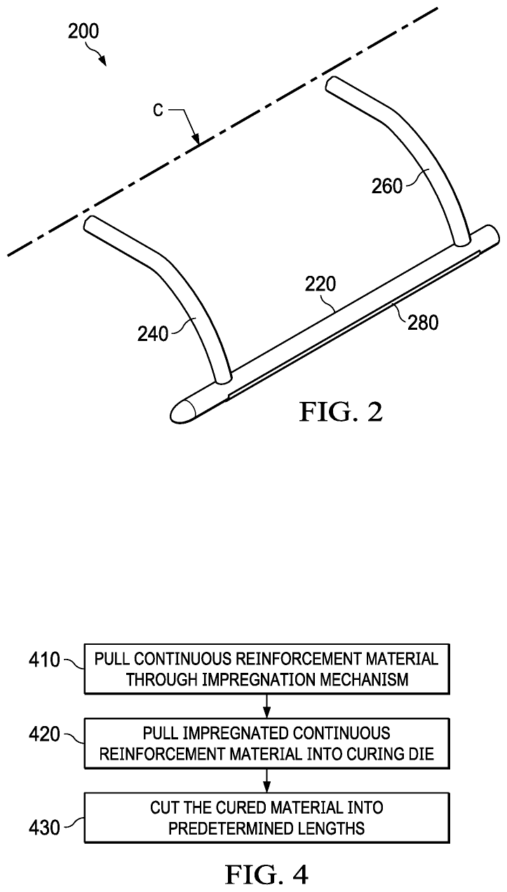

FIG. 2 illustrates a partial schematic diagram of the landing gear assembly 200 in accordance with implementations of various techniques described herein. In particular, FIG. 2 illustrates one half of the landing gear assembly 200, where one skid member 220 and portions of the cross members 240, 260 are displayed.

Those skilled in the art will understand that the other half of the landing gear assembly 200 is a mirror image of the assembly 200 shown in FIG. 2, such that another skid member 220 is included and each cross member 240, 260 is symmetrical about a central line C of the fuselage 120. Though not shown in FIG. 2, those skilled in the art will understand the front cross member 240 and the rear cross member 260 may each be in the shape of arches.

As noted above, conventional skid members may be manufactured from aluminum extrusions or seamless drawn aluminum tubes, where chemical milling may be used to reduce the weight of the skid members where possible. Chemical milling, however, may lead to environmental issues, increase manufacturing time, and the like.

As such, various implementations described herein may include the use of skid members 220 manufactured using composite material. Composite material may refer to material formed by combining two or more constituent materials with different physical or chemical properties that, when combined, produce a material with characteristics different from the individual components. Composite material may include reinforced polymers, such as fiberglass or fiber-reinforced polymers. One example of fiber-reinforced polymers may include carbon fiber reinforced polymers.

Composite material, such as carbon fiber reinforced polymers, may be relatively high in strength and low in weight, particularly when compared to metallic material, such as aluminum alloys. Accordingly, by using skid members 220 composed of composite material, such as carbon fiber reinforced polymers, chemical milling and its associated issues (e.g., environmental complications, increased manufacturing time, and the like) may be avoided. A skid member made of composite material may hereinafter be referred to as a composite skid member.

Various implementations for manufacturing a composite skid member 220 may be used. For example, such a skid member 220 may be fabricated using a filament winding process, a fiber placement process, a hand lay-up process, or the like. In one implementation, a composite skid member 220 may be manufactured using a pultrusion process. A composite skid member manufactured using a pultrusion process may hereinafter be referred to as a pultruded composite skid member. Compared to other methods for manufacturing composite material, a pultrusion process may be faster and more automated. As such, a pultrusion process may be relatively more cost-effective.

In one such implementation, the pultrusion process may include pulling reinforcement material, such as fibers (e.g., carbon fibers), through an impregnation mechanism (e.g., an atmospheric pressure bath) to impregnate it with a curable liquid resin. Once impregnated, the material may be pulled through a curing die to polymerize and set the resin, thereby yielding a product of composite material (e.g., carbon fiber reinforced polymer). The product may be cut to specific lengths using a saw or a similar device to form the pultruded composite skid member 220. Various implementations for the pultrusion process are described in more detail below.

In one implementation, a pultruded composite skid member 220 may have a constant cross-section throughout the length of the member 220, where the cross-section may be circular, rectangular, or any other shape known to those skilled in the art. In a further implementation, each pultruded composite skid member 220 may also have a scuff guard 280 coupled thereto, where the scuff guard 280 may be used to minimize wear on a pultruded composite skid member 220 by protecting the member 220 during landings and while the aircraft 100 is positioned on the ground. Each scuff guard 280 may be in the form of a shoe that is configured to surround at least a bottom portion of a pultruded composite skid member 220. Each scuff guard 280 may be coupled to a pultruded composite skid member 220 using any implementations known to those skilled in the art, including, but not limited to, screws, bolts, rivets, and the like. In one implementation, the scuff guards 280 may be composed of steel.

Further, the cross members 240, 260 may be coupled to the pultruded composite skid members 220 using any implementations known to those skilled in the art, including, but not limited to, screws, bolts, rivets, sleeves, saddles, and the like. The cross-sections of cross members 240, 260 may circular, rectangular, and/or any other shape known to those skilled in the art. In one implementation, the cross members 240, 260 may be made of metallic material. As such, the landing gear assembly 200 may include metallic cross members 240, 260 coupled to pultruded composite skid members 220. In one example, the landing gear assembly 200 may include cross members 240, 260 made of an aluminum alloy (e.g., 7075-T73511 or 7075-T6511), where the cross members 240, 260 are coupled to pultruded composite skid members 220 made of carbon fiber reinforced polymers.

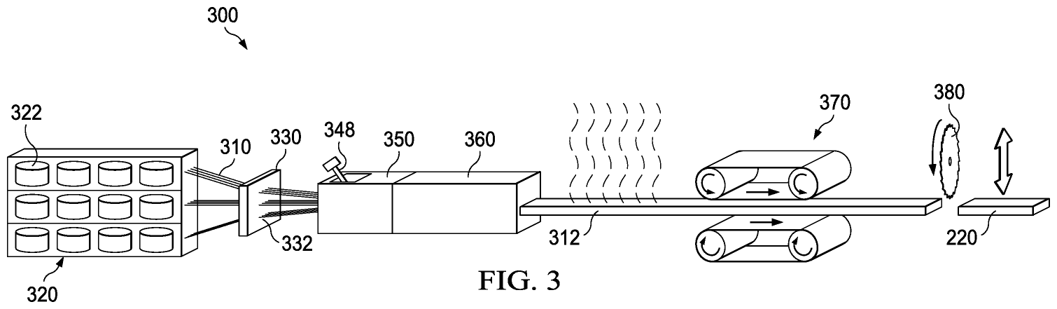

FIG. 3 illustrates a schematic diagram of a system 300 for producing a composite skid member 220 using a pultrusion process in accordance with implementations of various techniques described herein. Though FIG. 3 illustrates a particular configuration for the system 300, those skilled in the art will understand that other configurations for producing a composite skid member may be used.

As noted above, the composite material formed in a pultrusion process may include a fibrous reinforcement material (e.g., glass, polymeric, carbon fibers, or the like) embedded in a resin matrix (e.g., polyester, polyurethane, epoxy, or the like). The fibrous reinforcement material may initially be in various formations, including, but not limited to, a roving, tow, mat, woven, or stitched format.

For example, FIG. 3 illustrates that continuous carbon fibers may be in the form of fiber tows 310 that are provided on spools 322, where the spools 322 may be arranged on a fixture such as a creel 320. The spools 322 may be configured to allow each tow 310 to be fed through the creel 120 without interference or tangling. For example, the creel 320 may include a series of holes arranged in a manner such that the fiber tows 310 do not contact each other as they are being fed through the creel 320. The fiber tows 310 may be fed through a guide 332 of an infeed structure 330, where the guide 332 includes a plurality of apertures through which the fiber tows 310 may be fed in a pattern that is consistent with the final design shape of the composite skid member 220 to be manufactured.

As mentioned above, the reinforcement material may be pulled through an impregnation mechanism to impregnate it with a curable liquid resin. In one implementation, the impregnation mechanism may be an atmospheric pressure bath (e.g., an open bath). In another implementation, the impregnation mechanism may be a closed injection die with resin injection ports, where the resin is injected under pressure through the ports to impregnate the reinforcement material.

For example, FIG. 3 illustrates that the fiber tows 310 fed through the infeed structure 330 may enter an injection die 350, where the injection die 350 may be configured to coat individual filaments within each fiber tow 310 with resin using one or more resin injection ports 348. The resin used may include any that are known to those skilled in the art, including, but not limited to, polyester, polyurethane, and epoxy. The resin may be used to provide environmental resistance for the composite material, while the reinforcement material may be used to provide strength for the composite material.

The impregnated reinforcement material may then be pulled into a curing or heating die, where the resin may solidify and be cured within the die. The curing die may apply heat to the impregnated reinforcement material using any heating implementations known to those skilled in the art.

For example, FIG. 3 illustrates that a curing die 360 may be positioned next to the injection die 350 such that the impregnated carbon fiber tows 310 may be pulled into the curing die 360 for heat to be applied to the material. The die 360 may be composed of any suitable metal, such as steel, and may use any heating elements known in the art, such as electric heaters. A rigid, cured profile of the product 312 exiting the die 360 may be formed based on the shape of the die 360, where the product 312 may be a carbon fiber reinforced polymer. Further, the cured product 312 exiting the die 360 may be allowed to cool. As shown in FIG. 3, the cured product 312 may be extracted from the curing die 360 using a puller 370. The puller 370 may be any pulling mechanism known to those skilled in the art, including, but not limited to, reciprocating pulling systems or caterpillar-like pulling systems.

The cured product may then be cut to specific lengths using a saw or a similar device. For example, FIG. 3 illustrates that a saw 180 may be used to cut the cured product 312 (i.e., carbon fiber reinforced polymer) into defined lengths such that a pultruded composite skid member 220 may be formed, where the skid member 220 is made of carbon fiber reinforced polymer. In some implementations, the operation of the system 300 may be automated, such as through the use of one or more computing systems (not shown). Further, once two pultruded composite skid members 220 have been fabricated, the skid members 220 may then be coupled to metallic cross members 240, 260 to form the landing gear assembly 200 described above.

FIG. 4 illustrates a flow diagram of a method 400 for producing a composite skid member using a pultrusion process in accordance with implementations of various techniques described herein. In one implementation, method 400 may be at least partially performed by a computing system or may be performed using a system, such as system 300, described above. It should be understood that while method 400 indicates a particular order of execution of operations, in some implementations, certain portions of the operations might be executed in a different order. Further, in some implementations, additional operations or steps may be added to the method 400. Likewise, some operations or steps may be omitted.

At block 410, a system may pull continuous reinforcement material through an impregnation mechanism to impregnate the continuous reinforcement material with resin. In one implementation, the continuous reinforcement material may be continuous carbon fibers in the form of fiber tows. In a further implementation, the impregnation mechanism may be a closed injection die with resin injection ports, where the resin is injected under pressure through the ports to impregnate the continuous carbon fibers. The continuous carbon fibers may also be pulled using a pulling mechanism of the system.

At block 420, a system may pull the impregnated continuous reinforcement material into a curing die in order to cure the material. In one implementation, the curing die may apply heat to the impregnated carbon fibers, forming a rigid, cured product with a shape based on the shape of the die.

At block 430, a system may cut the cured material into predetermined lengths to form one or more pultruded composite skid members. In one implementation, a saw may be used to cut the cured material. The one or more pultruded composite skid members may then be coupled to one or more cross members to form a landing gear assembly.

In sum, the implementations disclosed herein may be used to utilize landing gear having composite skid members. By using such skid members, chemical milling and its associated issues (e.g., environmental complications, increased manufacturing time, and the like) may be avoided. In addition, composite skid members, such as those composed of carbon fiber reinforced polymers, may be relatively high in strength and low in weight when compared to metallic skid members. Furthermore, compared to other methods for manufacturing composite material, a pultrusion process may be faster and more automated. As such, using pultruded composite skid members may be relatively cost-effective when compared to other composite skid members.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

what is claimed is:

1. An aircraft landing gear assembly, comprising:
two skid members configured to contact the ground, wherein each skid member comprises composite material manufactured using a pultrusion process; and
a plurality of cross members configured to couple to a fuselage of an aircraft and configured to interconnect the two skid members.

2. The aircraft landing gear assembly of claim 1, wherein the plurality of cross members comprises a front cross member and a rear cross member.

3. The aircraft landing gear assembly of claim 1, wherein the composite material comprises carbon fiber reinforced polymer.

4. The aircraft landing gear assembly of claim 1, wherein each skid member has a constant cross-section throughout its length.

5. The aircraft landing gear assembly of claim 1, further comprising a scuff guard coupled to each skid member, wherein the scuff guard is configured to surround at least a bottom portion of each skid member.

6. The aircraft landing gear assembly of claim 5, wherein the scuff guard is composed of steel.

7. The aircraft landing gear assembly of claim 1, wherein the plurality of cross members is composed of metallic material.

8. The aircraft landing gear assembly of claim 1, wherein the plurality of cross members is made of an aluminum alloy.

9. The aircraft landing gear assembly of claim 1, wherein the aircraft comprises a helicopter.

10. The aircraft landing gear assembly of claim 1, wherein the composite material manufactured using the pultrusion process comprises composite material manufactured by:
pulling reinforcement material through an impregnation mechanism;
impregnating the reinforcement material with resin;
curing the impregnated reinforcement material using a die to form a cured product; and
cutting the cured product at a predetermined length to form a respective skid member.

11. An aircraft, comprising:
a fuselage;
an aircraft landing gear assembly, comprising:
two skid members configured to contact the ground, wherein each skid member comprises composite material; and
a plurality of cross members configured to couple to the fuselage and configured to interconnect the two skid members.

12. The aircraft of claim 11, wherein each skid member comprises composite material manufactured using a pultrusion process.

13. The aircraft of claim 11, wherein the composite material comprises carbon fiber reinforced polymer.

14. The aircraft of claim 11, wherein the aircraft landing gear assembly further comprises a scuff guard coupled to each skid member, wherein the scuff guard is configured to surround at least a bottom portion of each skid member.

15. The aircraft of claim 11, wherein the plurality of cross members is composed of metallic material.

16. The aircraft of claim 11, wherein each skid member comprises composite material is manufactured by:
pulling reinforcement material through an impregnation mechanism;
impregnating the reinforcement material with resin;
curing the impregnated reinforcement material using a die to form a cured product; and
cutting the cured product at a predetermined length to form a respective skid member.

17. A method, comprising:
pulling continuous reinforcement material through an impregnation mechanism to impregnate the continuous reinforcement material with resin;
pulling the impregnated continuous reinforcement material through a curing die to form a cured product; and
cutting the cured product into predetermined lengths to form one or more pultruded composite skid members for use with an aircraft landing gear assembly.

18. The method of claim 17, wherein:
the continuous reinforcement material comprises continuous carbon fibers; and
the impregnation mechanism comprises a closed injection die with one or more resin injection ports, wherein the resin is injected under pressure through the one or more resin injection ports to impregnate the continuous carbon fibers.

19. The method of claim 18, wherein:
the curing die is configured to apply heat to the impregnated continuous carbon fibers to form the cured product; and
the shape of the cured product is based on a shape of the curing die.

20. The method of claim 17, further comprising coupling the one or more pultruded composite skid members with one or more metallic cross members for use with the aircraft landing gear assembly.
